(19) United States
(12) Patent Application Publication
(10) Pub. No.: US 2016/0349934 A1
(43) Pub. Date: Dec. 1, 2016

(54) ELECTRONIC DEVICE AND METHOD FOR GENERATING MULTIPLE INTERFACES IN THE ELECTRONIC DEVICE

(71) Applicant: HON HAI PRECISION INDUSTRY CO., LTD., New Taipei (TW)

(72) Inventor: YOUNG-WAY LIU, New Taipei (TW)

(21) Appl. No.: 15/149,191

(22) Filed: May 9, 2016

(30) Foreign Application Priority Data
May 27, 2015 (TW) 104116943

(51) Int. Cl. G06F 3/0481; H04M 1/725

(52) U.S. Cl. CPC G06F 3/0481; H04M 1/72527

(57) ABSTRACT

An electronic device and a method for generating interfaces are provided. The electronic device includes a plurality of subscriber identity module (SIM) cards. Each of the SIM cards is associated with a predetermined number of applications. Conditions for generating graphical interfaces in a screen of the electronic device are set. The electronic device generates the graphical interfaces in the screen of the electronic device when the conditions are triggered, and each of the graphical interfaces for displaying an application associated with a SIM card.

### CROSS-REFERENCE TO RELATED APPLICATIONS

This application claims priority to Taiwanese Patent Application No. 104116943 filed on May 27, 2015, the contents of which are incorporated by reference herein.

### FIELD

The embodiments of the present disclosure relate to interface management technology, and particularly to an electronic device and method for generating multiple interfaces in the electronic device.

### BACKGROUND

Since a mobile electronic device (for example, smart phone) is often used as a personal organizer, mobile electronic devices can include personalization capability, such as providing two or more subscriber identity module (SIM) cards. For example, the mobile electronic device includes a SIM card A and a SIM card B. The mobile electronic device provides a same interface for the two or more SIM cards.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a diagrammatic view of an exemplary embodiment of an interface generating system included in an electronic device.

FIG. 2 shows a block diagram of an exemplary embodiment of the interface generating system.

FIG. 3 is a flowchart of an exemplary embodiment of a method for generating interfaces in the electronic device.

FIGS. 4-7 show a diagrammatic view of an exemplary embodiment of generating graphical interfaces on a screen of the electronic device.

FIG. 8 shows a diagrammatic view of an exemplary embodiment of merging the graphical interfaces into a combined graphical interface.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable median include CDs, DVDs, BLU-RAY™, flash memory, and hard disk drives. The term “comprising” means “including, but not necessarily limited to”; it specifically indicates open-ended inclusion or membership in a so-described combination, group, series and the like.

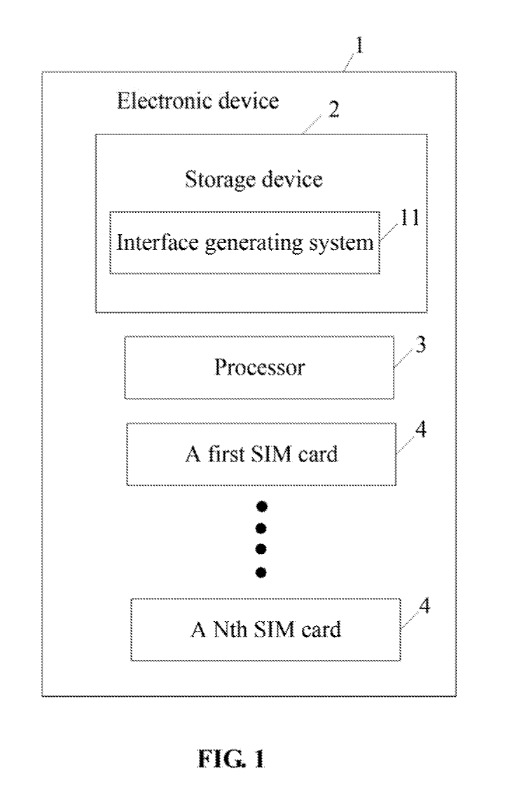

FIG. 1 is a diagrammatic view of an exemplary embodiment of an interface generating system 11 included in an electronic device 1. The electronic device 1 includes, but is not limited to, a storage device 2, at least one processor 3, a plurality of subscriber identity module (SIM) cards 4. The SIM cards 4 can include, for example, a first SIM card 4 to an Nth SIM card 4 as shown in FIG. 1. The electronic device 1 can be, but is not limited to, a mobile phone, a tablet computer, a personal digital assistant (PDA), a personal computer or any other electronic devices. FIG. 1 illustrates only one example of the electronic device 1, and other examples can comprise more or fewer components that those shown in the embodiment or have a different configuration of the various components.

In at least one embodiment, the storage device 2 can be an internal storage device, such as a flash memory, a random access memory (RAM) for temporary storage of parameters, and/or a read-only memory (ROM) for permanent storage of parameters. The storage device 2 can also be an external storage device, such as an external hard disk, a storage card, or a data storage medium. The at least one processor 3 can be a central processing unit (CPU), a microprocessor, or other data processor chip that performs functions of the electronic device 1.

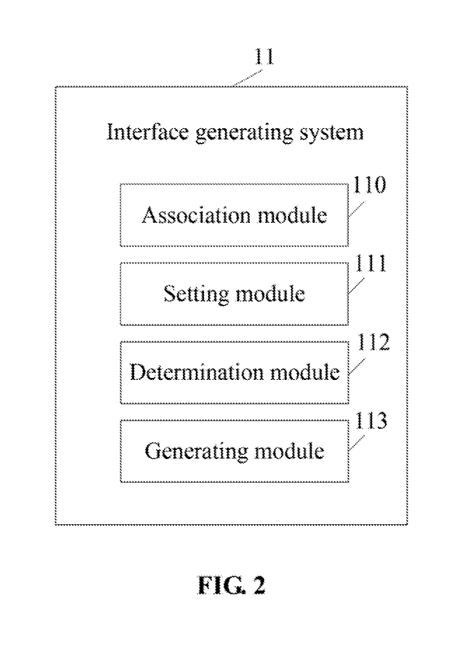

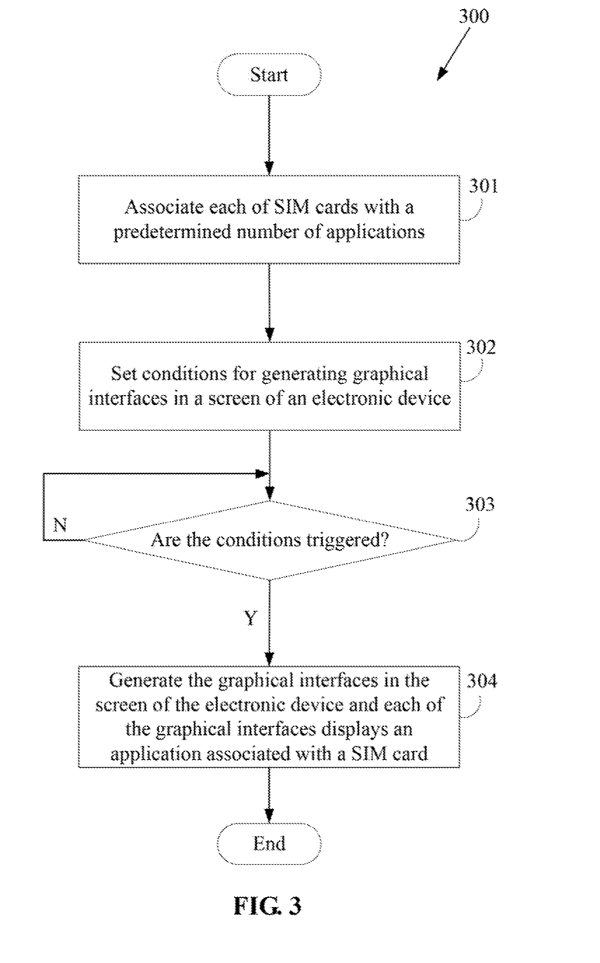

FIG. 2 is a block diagram of one embodiment of the interface generating system 11. The interface generating system 11 comprises, but is not limited to, an association module 110, a setting module 111, a determination module 112, and a generation module 113. Modules 110-113 can comprise computerized instructions in the form of one or more computer-readable programs that can be stored in a non-transitory computer-readable medium, for example the storage device 2, and executed by the at least one processor 3 of the electronic device 1. A detailed description of the functions of the modules 110-113 is given below in reference to FIG. 3.

FIG. 3 illustrates a flowchart of an example embodiment of a method for generating interfaces presented by the electronic device 1. In an example embodiment, the method is performed by execution of computer-readable software program codes or instructions by at least one processor of the electronic device 1.

Referring to FIG. 3, a flowchart is presented in accordance with an example embodiment. The method 300 is provided by way of example, as there are a variety of ways to carry out the method. The method 300 described below can be carried out using the configurations illustrated in FIGS. 1-2, for example, and various elements of these figures are referenced in explaining method 300. Each block shown in FIG. 3 represents one or more processes, methods, or subroutines, carried out in the method 300. Furthermore, the illustrated order of blocks is illustrative only and the order of the blocks can be changed. Additional blocks can be added or fewer blocks can be utilized without departing from this disclosure. The example method 300 can begin at block 301.

In step 301, the association module associates each of SIM cards in an electronic device with a predetermined number (for example, fifty) of applications of the electronic device. The applications can be, but are not limited to, a contact application, a short message application, a phone application, a calendar application, a search application, a shopping application or any other applications. The electronic device can include one or more operating system (OS). All of the applications can be installed at one operating system or different OSs. For example, a part of the applications (for example, a contact application, a short message application, a phone application) are installed at the one OS, and another part of the applications (for example, a calendar application, a search application, a shopping application, a desktop application or the like) are installed at another OS. In addition, different SIM cards can be associated with the same application, for example, the first SIM card is associated with the phone application, and the second SIM card can be also associated with the phone application. Each of the SIM cards can independently control the associated applications. In one embodiment, each of the SIM cards has a specific propose. For example, the first SIM card is for company businesses (for example, send an email to a supplier) of a user, and the second SIM card is for private things (for example, chat with a friend or the like) of the user.

In step 302, the setting module sets conditions for generating graphical interfaces in a screen of the electronic device.

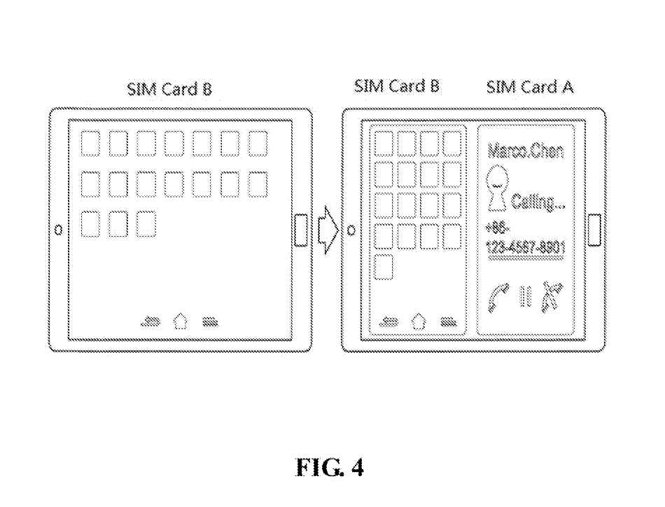

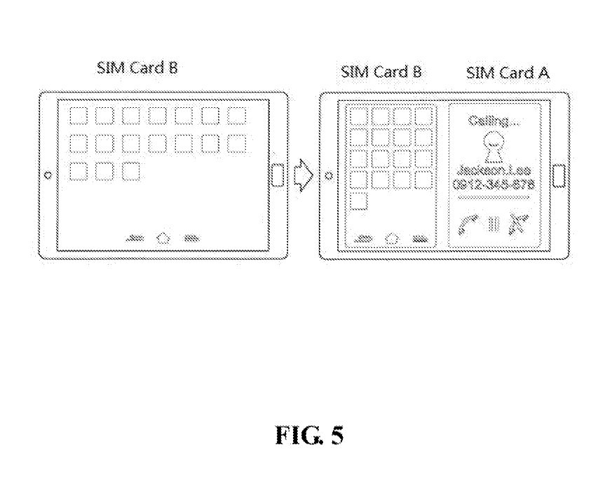

In at least one embodiment, the conditions can be triggered to generate the graphical interfaces in the screen of the electronic device when the applications (for example, two applications) associated with various SIM cards run in the electronic device and each of the graphical interfaces displays one of the applications. For example, the desktop application associated with the SIM card B runs in the electronic device 1. The phone application associated with the SIM card A is triggered. For example, a telephone number of a user who is Micro Chen is called using the phone application associated with the SIM card A as shown in FIG. 4, or the phone application associated with the SIM card A receives a call from a user who is Jackson Lee as shown in FIG. 5. Two graphical interfaces are generated in the screen of the electronic device. The two graphical interfaces are independent, and each of the two graphical interfaces displays one of the applications. One of the graphical interfaces displays the desktop application, and another of the graphical interfaces displays the phone application.

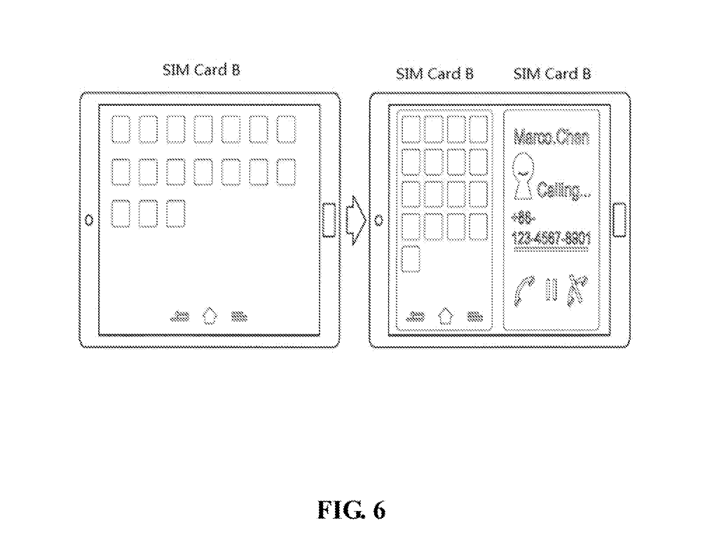

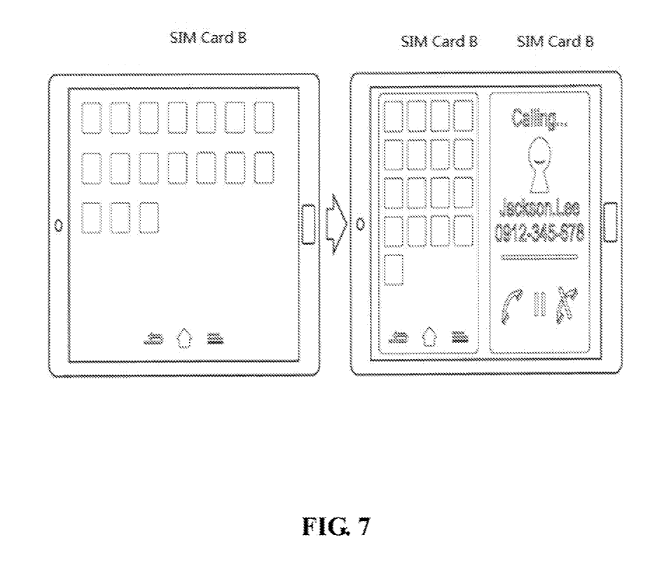

In at least one embodiment, the conditions can be triggered to generate the graphical interfaces in the screen of the electronic device 1 when the applications (for example, two applications) associated with the same SIM cards run in the electronic device 1 and each of the graphical interfaces displays one of the applications. For example, the desktop application associated with the SIM card B runs in the electronic device 1. The phone application associated with the SIM card B is triggered. For example, the telephone number of the user who is Micro Chen is called using the phone application associated with the SIM card B as shown in FIG. 6, or the phone application associated with the SIM card B receives a call from the user who is Jackson Lee as shown in FIG. 7. Two graphical interfaces are generated in the screen of the electronic device 1. One of the graphical interfaces displays the desktop application, and another of the graphical interfaces displays the phone application.

In at least one embodiment, the setting module 111 can set the conditions associated with a specific key of a keyboard of the electronic device 1. When the specific key is pressed by the user of the electronic device 1, the graphical interfaces are generated. The number of the graphical interfaces can be equal to times that the specific key is pressed. For example, when the specific key is pressed twice, two graphical interfaces are generated.

In step 303, the determination module determines if the conditions are triggered. If the conditions are triggered, the procedure goes to block 304. Otherwise, if the conditions are not triggered, block 303 is repeatedly executed until the conditions are triggered.

In step 304, the generation module 113 generates the graphical interfaces in the screen of the electronic device 1, and each of the graphical interfaces displays an application associated with one of the SIM cards. For example, as shown in FIGS. 4-5, the generation module generates two graphical interfaces in the screen of the electronic device, one graphical interface displays the desktop application associated with the SIM card B, and the other one graphical interface displays the phone application associated with the SIM card A. For example, as shown in FIGS. 6-7, the generation module generates two graphical interfaces on the screen of the electronic device. One graphical interface displays the desktop application associated with the SIM card B, and the other one graphical interface displays the phone application associated with the SIM card B.

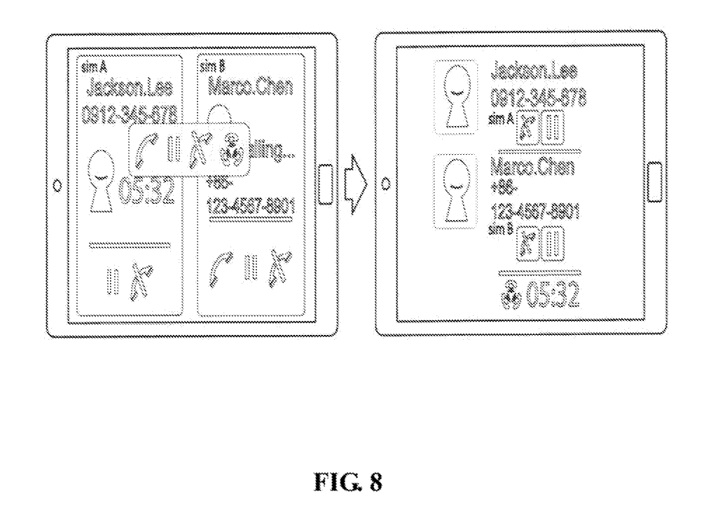

In addition, the graphical interfaces can be merged into a combined graphical interface which displays two or more applications. As shown in FIG. 8, two graphical interfaces display two application. One graphical interface displays the phone application associated with the SIM card A (also can be named as sim A shown in FIG. 8). Another graphical interface displays the phone application associated with the SIM card B (also can be named as sim B shown in FIG. 8). The two graphical interfaces which respectively display the phone application can be merged into the combined graphical interface as shown in FIG. 8.

Furthermore, each of the graphical interfaces may include a name of the SIM cards. For example, as shown in FIG. 8, the name of the SIM card (sim A) and the name of the SIM card (sim B) are shown in the graphical interfaces.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device comprising:
a plurality of subscriber identity module (SIM) cards;
at least one processor coupled to the plurality of SIM cards; and
a storage device that stores one or more programs, which when executed by the at least one processor, cause the at least one processor to:
associate each of the plurality of SIM cards with a predetermined plurality of applications;
set conditions for generating graphical interfaces on a screen of the electronic device;
determine if one of the set conditions are triggered; and
generate the graphical interfaces on the screen of the electronic device when the conditions are triggered, and each of the graphical interfaces for displaying an application associated with a SIM card.

2. The electronic device of claim 1, wherein the electronic device comprises one or more operating systems, all of the applications are installed at one operating system or different operating systems.

3. The electronic device of claim 1, wherein the conditions are triggered to generate the graphical interfaces in the screen of the electronic device when the applications associated with various SIM cards run in the electronic device.

4. The electronic device of claim 1, wherein the conditions are triggered to generate the graphical interfaces in the screen of the electronic device when the applications associated with the same SIM card runs in the electronic device.

5. The electronic device of claim 1, wherein the conditions are triggered to generate the graphical interfaces in the screen of the electronic device when a specific key of a keyboard of the electronic device is pressed.

6. The electronic device of claim 1, wherein the graphical interfaces can be merged into a combined graphical interface which displays two or more applications.

7. The electronic device of claim 1, wherein the graphical interfaces are independent, and each of the graphical interfaces displays one of the applications.

8. A computer-based method for generating interfaces using an electronic device having a plurality of subscriber identity module (SIM) cards, the method comprising:
associating each of the plurality of SIM cards with a predetermined plurality of applications;
setting conditions for generating graphical interfaces on a screen of the electronic device;
determining if one of the set conditions are triggered; and
generating the graphical interfaces on the screen of the electronic device when the conditions are triggered, and each of the graphical interfaces for displaying an application associated with a SIM card.

9. The method of claim 8, wherein the electronic device comprises one or more operating systems, all of the applications are installed at one operating system or different operating systems.

10. The method of claim 8, wherein the conditions are triggered to generate the graphical interfaces in the screen of the electronic device when the applications associated with various SIM cards run in the electronic device.

11. The method of claim 8, wherein the conditions are triggered to generate the graphical interfaces in the screen of the electronic device when the applications associated with the same SIM card runs in the electronic device.

12. The method of claim 8, wherein the conditions are triggered to generate the graphical interfaces in the screen of the electronic device when a specific key of a keyboard of the electronic device is pressed.

13. The method of claim 8, wherein the graphical interfaces can be merged into a combined graphical interface which displays two or more applications.

14. The method of claim 8, wherein the graphical interfaces are independent, and each of the graphical interfaces displays one of the applications.

15. A non-transitory computer-readable medium having stored thereon instructions that, when executed by at least one processor of an electronic device, causing the processor to perform a method for generating interfaces using an electronic device having a plurality of subscriber identity module (SIM) cards, the method comprising:
associate each of the plurality of SIM cards with a predetermined plurality of applications;
set conditions for generating graphical interfaces on a screen of the electronic device;
determine if one of the set conditions are triggered; and
generate the graphical interfaces on the screen of the electronic device when the conditions are triggered, and each of the graphical interfaces for displaying an application associated with a SIM card.

16. The non-transitory computer-readable medium of claim 15, wherein the electronic device comprises one or more operating systems, all of the applications are installed at one operating system or different operating systems.

17. The non-transitory computer-readable medium of claim 15, wherein the conditions are triggered to generate the graphical interfaces in the screen of the electronic device when the applications associated with various SIM cards run in the electronic device.

18. The non-transitory computer-readable medium of claim 15, wherein the conditions are triggered to generate the graphical interfaces in the screen of the electronic device when the applications associated with the same SIM card runs in the electronic device.

19. The non-transitory computer-readable medium of claim 15, wherein the conditions are triggered to generate the graphical interfaces in the screen of the electronic device when a specific key of a keyboard of the electronic device is pressed.

20. The non-transitory computer-readable medium of claim 15, wherein the graphical interfaces can be merged into a combined graphical interface which displays two or more applications.
